(19) United States
(12) Patent Application Publication
(10) Pub. No.: US 2017/0063979 A1
(43) Pub. Date: Mar. 2, 2017

(54) RECEPTION PACKET DISTRIBUTION METHOD, QUEUE SELECTOR, PACKET PROCESSING DEVICE, AND RECORDING MEDIUM

(71) Applicant: NEC CORPORATION, Tokyo (JP)

(72) Inventor: Shuichi SAEKI, Tokyo (JP)

(21) Appl. No.: 15/119,548

(22) PCT Filed: Feb. 4, 2015
(86) PCT No.: PCT/JP2015/053718

§ 371 Date: Aug. 17, 2016

(30) Foreign Application Priority Data
Mar. 19, 2014 (JP) 2014-056036

(51) Int. Cl. H04L 29/08; H04L 12/46; G06F 9/50; H04L 29/06

(52) U.S. Cl. CPC H04L 67/1023; H04L 69/22; H04L 12/4641; G06F 9/50

(57) ABSTRACT

To enable scaling of the ability to process user data packets based on the number of CPU cores, this queue selector includes: a receiver that receives user data packets as reception packets; an extractor that extracts a user IP address in the payload of a reception packet; a calculator/selector that calculates a hash value for the extracted user IP address and, on the basis of the hash value, selects the queue number of a queue in which the reception packet should be stored; a determiner that references a determination table storing a respective CPU utilization rate for each of the multiple CPU cores, and determines on the basis of the CPU utilization rate whether to set the selected queue number as the queue number of the queue in which the reception packet should be stored; and storage that stores the reception packet in the queue having the selected queue number.

### TECHNICAL FIELD

The present invention relates to a packet processing device that receives and processes user data packets from mobile terminals, and more particularly to a reception packet distribution method, a queue selector, a packet processing device, and a recording medium that properly distribute user data packets input from the outside over a plurality of CPU (central processing unit) cores allocated to a virtual machine.

### BACKGROUND ART

In recent years, it has been studied to virtualize a mobile network, such as an EPC (Evolved Packet Core), which contains an LTE (Long Term Evolution) network and the like, by using NFV (Network Functions Virtualization). In this case, a data plane packet processing device that receives and processes user data packets from mobile terminals is achieved on a virtual machine.

Here, NFV means a method for implementing, as software, a function of a communication device that controls a network, and running on a virtualized OS (operating system) in a general-purpose server.

The EPC has a capability of containing a new LTE access network while containing a conventional 2G/3G network which is defined in the 3GPP (3rd Generation Partnership Project). The EPC is further capable of containing various types of access networks including a non-3GPP access, such as a WLAN (wireless Local Area Network), WiMAX (Worldwide Interoperability for Microwave Access), 3GPP2, and the like. The EPC is configured of an MME (Mobility Management Entity), an S-GW (Serving Gateway), and a P-GW (Packet data network gateway), and, furthermore, can provides a gateway into which an S-GW and a P-GW are integrated.

Here, the MME is a node that performs mobility management, such as location registration of an LTE terminal, terminal call processing at arrival of an incoming call, and handover between wireless base stations. The S-GW is a node that processes user data, such as a voice and packets from mobile terminals that access an LTE and a 3G system. The P-GW is a node that has an interface between a core network and an IMS (IP Multimedia Subsystem) or an external packet network. The IMS is a subsystem for achieving multimedia applications based on IP (Internet Protocol).

In virtualization of NFV, functions of the MME that is in charge of mobility control and the like, an HSS (Home Subscriber Server) that manages subscriber information, a PCRF (Policy and Charging Pules Function) that controls communication functions in accordance with a policy, and the S/P-GW that transmits packets, in a mobile core network device (EPC) that contains an LTE base station, which is a portion enclosed by a rectangle in FIG. 1, are achieved on a virtualization infrastructure in a general-purpose IA (Intel® Architecture) server in an all-in-one manner.

The IA server is a server that, based on the same architecture as a regular personal computer, mounts an Intel-compatible CPU such as an IA-32 or IA-64 series CPU (Central Processing Unit) produced by Intel Corporation or an AMD® (Advanced Micro Devices, Inc.) CPU. The IA server is also referred to as a PC server. The PC server is a server that is designed and produced based on a personal computer (PC).

In FIG. 1, an eNB (evolved NodeB) is a wireless base station (e-NodeB) in LTE. A mobile terminal in the drawing is assumed to be a so-called feature phone, a smart phone, or a tablet computer.

As described afore, NFV is aimed at enabling networks, such as a mobile core which is achieved by dedicated hardware, to be achieved by software in a general-purpose server. The data plane packet processing device is achieved as software on a virtual machine that is configured through virtualization on a multi-core CPU mounted on a general-purpose server. The multi-core CPU is provided with a plurality of CPU cores.

To improve the processing performance of the data plane packet processing device on the multi-core CPU, it is required to perform packet processing operations on the plurality of CPU cores and further scale performance in accordance with the number of CPU cores.

To achieve performance scaling in accordance with the number of CPU cores to be used by software processing, the following method is generally employed. First, from an NIC (Network Interface Card) which is a packet reception unit of a general-purpose server, a reception dedicated CPU core on a virtual machine picks packets. Next, the packets are assigned to the respective CPU cores (packet processing cores). Then, the respective CPU cores (packet processing cores) that receive the packets perform packet processing.

To improve performance, it is required to properly allot (distribute) user data packets (reception packets) input from the outside to the plurality of CPU cores allocated to the virtual machine.

Various prior arts (related technologies) concerning such a method for distributing reception packets are conventionally known.

For example, JP 2010-226275 A (PLT 1) discloses a “communication device” that, when processing packets by using a multi-core processor, is capable of using the resources of the multi-core processor effectively.

The communication device disclosed in PLT 1 employs a method of, when determining to which multi-core processor unit among a plurality of multi-core processor units data packets are to be output, determining an output destination multi-core processor unit based on a value calculated from information, such as the “destination IP address”, the “source IP address”, and the “protocol number” of IP data packet by using a hash function. Inside each multi-core processor unit, a plurality of cores are arranged. Each core is configured to be capable of executing a plurality of threads at the same time. A reception control unit has functions of storing newly received data packets into a main memory and handing over processing of the above-described data packets in a form of work to a work control unit to request the work control unit to allocate threads to the work.

JP 2011-077746 A (PLT 2) discloses a “network relay device” in which each core is capable of processing packets in parallel to the maximum extent possible.

The network relay device disclosed in PLT 2 is configured of a reception waiting queue, a lower-level flow identification unit, an upper-level flow identification waiting queue, a transfer processing waiting queue, an upper-level flow identification/transfer processing unit, and a transmission waiting queue. The network relay device, when receiving packets, holds the packets in the reception waiting queue temporarily. The lower-level flow identification unit picks out a packet from the reception waiting queue, calculates a hash function by using, for example, header information, such as a source IP address and a destination IP address in the IP header, and, in accordance with the calculated hash function, assign the packet into an upper-level flow identification waiting queue with respect to each lower-level flow. The upper-level flow identification/transfer processing unit is a processing unit that makes two types of processing, namely upper-level flow identification processing and transfer processing, reside together on one core. Although a multi-core CPU is used in the example, the invention may be embodied by using a plurality of CPUs.

Furthermore, JP 2009-239374 A (PLT 3) discloses a “virtual machine system” that is capable of decreasing packet transmission delays in VNICs (Virtual Network Interface Card) of a plurality of virtual machines.

In the virtual machine system disclosed in PLT 3, the plurality of virtual machines and a physical NIC are interconnected by a common bus. Each of the virtual machines has a virtual network interface card (VNIC). The physical network interface card (physical NIC) is connected to the common bus and shared (used in common) by the VNICs. The physical NIC processes packets received from a network in the order of reception. A network I/F, when receiving reception packet data with a reception packet number 1 (hereinafter, simply referred to as a number 1) from the network, stores the reception packet data into a reception buffer. The reception buffer extracts IP address data of a receiving target from the stored reception packet data with the number 1 and selects a reception queue corresponding to the IP address of the reception packet.

Furthermore, JP 2011-141587 A (PLT 4) discloses a “distributed processing system” that is capable of shortening response time for a single unit of data that is uploaded on a network and has a large amount of information.

The distributed processing system disclosed in PLT 4 is configured of including a reception response device, a divide/integrate device, a plurality of processing devices, and one or more queue monitoring devices. The reception response device receives data (upload data) from user terminals via a network. The divide/integrate device obtains data that the reception response device accepts, generates segment data by dividing the data, and further integrates processed segment data. The plurality of processing devices obtain segment data and perform data processing. The one or more queue monitoring devices obtain segment data output from the divide/integrate device, store the segment data as a queue, and, in response to a request from a processing device, transmit segment data to the processing device. The processing device obtains segment data from the queue management device and performs predetermined data processing to the obtained segment data. The processing device is configured of including a queue selection unit, a segment data obtaining unit, a data processing unit, and a segment data result output unit. The queue selection unit selects the queue management device that becomes a source of obtainment of segment data. Selection of the queue management device at this time is performed by using, for example, a distributed algorithm, such as a round-robin method. The segment data obtaining unit transmits an obtaining request for segment data to the queue management device selected by the queue selection unit, and obtains segment data from the queue management device.

### CITATION LIST

### Patent Literature

[PLT 1] JP 2010-226275 A (paragraphs [0013] and [0015]

[PLT 2] JP 2011-077746 A (paragraphs [0013], [0015], [0023], and [0024])

[PLT 3] JP 2009-239374 A (FIGS. 1 and 9, paragraphs [0025], [0069], and [0070])

[PLT 4] JP 2011-141587 A (FIG. 1, paragraphs [0031] to [0033] and to [0057])

### SUMMARY OF INVENTION

### Technical Problem

When a general-purpose server is virtualized by NFV and a user data processing device is configured on a virtual machine in the virtualized server, there is a problem in throughput performance. That is because, differing from a user data processing device configured with network specific hardware, all the functions are achieved by software.

For example, a user data processing device configured on a virtual machine, by using general-purpose functions such as SRIOV (Single Root I/O Virtualization) and a VF (Virtual Function) pass-through function, enables communication with the outside from a Guest OS (virtual machine) side via directly an NIC without passing through a host OS. Therefore, overheads required for communication with the host OS side can be eliminated, and, then, performance can be improved. However, there is a problem in that performance cannot be scaled in accordance with the number of CPU cores unless user packet data input from the outside is properly distributed to a plurality of CPU cores allocated to the virtual machine. That is because processing loads are weighted toward specific CPU cores and all the CPU core resources cannot be used up. Although there is no problem in the case of a single CPU core, it is impossible to increase performance in proportion to the number of CPU cores on a multi-core processor.

In the related technologies, it is possible to arrange a reception dedicated core in addition to a plurality of packet processing cores as a plurality of CPU cores, and, as disclosed in, for example, the above-described PLT 4, distribute reception packets by the reception dedicated core allotting the reception packets to the respective packet processing cores by using a round-robin logic or the like. However, there is a possibility that, because of variation in the lengths and the like of received packets, long packets or short packets are allotted to specific packet processing cores in a concentrated manner. The load on a CPU core per packet fluctuates depending on the packet size. Therefore, from the viewpoint of the load on CPU cores, an imbalance occurs as a result, and it is impossible to scale performance in proportion to the number of CPU cores. As a consequence, processing performance cannot be maximized.

It is also conceivable that, to solve such problems, the allotment logic used by the reception dedicated core is changed. However, in this case, the allotment logic becoming complicated causes allotment performance to decrease, the number of CPU cores (packet processing cores) over which loads can be distributed to decrease, and the number of CPU cores that can be scaled to be restricted. As a consequence, there is a problem in that performance on a multi-core processor cannot be maximized.

Even in a simple logic, such as a round-robin method, processing of receiving packets, determining a transfer destination CPU core (packet processing core), and transferring the packets is caused. Therefore, there is a problem in that, when the number of transfer destination CPU cores (packet processing cores) increases, a load on exclusion control among the respective CPU cores (packet processing cores), which is caused in performing packet transfer, increases, the reception dedicated core becomes a bottleneck, and performance cannot be scaled.

User data used in a mobile network such as an EPC are encapsulated by GTP (General Tunnel Protocol), provided with node IP addresses for inter-node device communication, and communicated by using the node IP addresses. All the node IP addresses representing devices that receive packets become the same destination IP address. It is possible to, by using an RSS (Receive Side Scaling) function implemented to a general-purpose NIC, distribute packets in accordance with IP addresses on the NIC side. However, there is a problem in that, since node IP addresses used in a mobile network, such as an EPC, become the same value as IP addresses of packet processing devices, it is actually impossible to distribute packets.

Furthermore, there is a problem in that, since user IP address to be distributed exist in the payload of encapsulated packet, the RSS function equipped on a general-purpose NIC is incapable of referring to the user IP address.

Summarizing the above, load distribution methods for reception packets in a packet processing device, which is configured in a virtual environment using related technologies, such as NFV, have the following problems.

A first problem is that, in devices according to the related technologies, packet processing performance per CPU core deteriorates because of overhead caused by occupation of CPU core resources as a reception dedicated core and, in addition, packet exchanges between packet processing cores and the reception dedicated core. The reason for the problem is as follows. When a plurality of VFs are constructed in an NIC by using functions, such as SRIOV, only one reception packet queue can be configured in a VF. Therefore, it is required to arrange the reception dedicated core that picks the reception packets from the reception packet queues in the NIC.

A second problem is that distribution of packets with respect to each mobile terminal cannot be achieved, loads concentrate on specific reception packet queues or packet processing cores, and, even when the number of CPU cores performing packet processing is increased, packet processing performance cannot be scaled in accordance with the number of CPU cores. The reason for the problem is as follows. It is assumed that a plurality of reception packet queues are constructed in a VF similarly to a PF (Physical Function) function in an NIC, and an NIC card that is capable of distributing packets over the respective reception packet queues by using RSS functions is achieved. Even in this case, user packet data on a mobile network, such as an EPC, are encapsulated by GTP. Therefore, IP addresses of mobile terminals are contained inside payloads, and an IP address given to the header of a packet is a node IP address for performing transmission and reception among respective nodes within the EPC. As a consequence, for RSS function normally equipped in an NIC, reception packets can be distributed over the respective reception packet queues in the NIC based only on this node IP addresses.

A third problem is that it is impossible to smooth loads on respective packet processing cores in accordance with modes of use by users or characteristics of applications, and, even when the number of CPU cores performing packet processing is increased, it is impossible to scale packet processing performance in accordance with the number of CPU cores. The reason for the problem is as follows. Even when packet distribution based on the user IP addresses of mobile terminals is achieved, the data lengths of user packets are not uniform, and packet lengths differ every user or every application. As a consequence, as the length of packet data to be processed varies, loads on the CPU cores fluctuate for each packet.

PLT 1 merely discloses a technical idea of, based on a value calculated from IP data packet information by use of a hash function, determining an output destination multi-core processor unit.

PLT 2 merely discloses a technical idea of, when receiving packets, holding the packets in a reception waiting queue temporarily, extracting a packet from the reception waiting queue, calculating a hash function by using header information in the IP header of the extracted packet, assigning the packet into an upper-level flow identification waiting queue with respect to each lower-level flow based on the calculated hash value, picking packets waiting in upper-level flow identification waiting queues, and performing upper-level flow identification processing.

PLT 3 merely discloses a technical idea of extracting IP address data of a receiving target from reception packet data and selecting a reception queue with respect to the IP address of the reception packet.

PLT 4, as described afore, merely discloses a technical idea of performing selection of a queue management device by using a distributed algorithm, such as a round-robin method.

An object of the present invention is to provide a reception packet distribution method, a queue selector, a packet processing device, and a recording medium that are capable of scaling processing performance of user data packets in accordance with the number of CPU cores.

### Solution to Problem

One exemplary embodiment of the present invention is a reception packet distribution method of receiving a user data packet from a mobile terminal as a reception packet and distributing the reception packet to a plurality of queues, the queues corresponding to a plurality of CPU cores allocated to a virtual machine respectively and assigned queue numbers respectively. The method includes: receiving the user data packet as the reception packet; extracting a user IP address located in a payload of the reception packet; calculating a hash value of the extracted user IP address and selecting a queue number of a queue into which the reception packet is to be stored based on the hash value; referring to a determination table storing a CPU utilization rate with respect to each of the plurality of CPU cores and determining whether or not the selected queue number is settled as a queue number of a queue into which the reception packet is to be stored based on the CPU utilization rate; and storing the reception packet into a queue with the determined queue number.

### Advantageous Effects of Invention

The present invention enables processing performance of user data packets to be scaled in accordance with the number of CPU cores.

### BRIEF DESCRIPTION OF DRAWINGS

FIG. 1 is a diagram describing an example of virtualizing a mobile network by NFV;

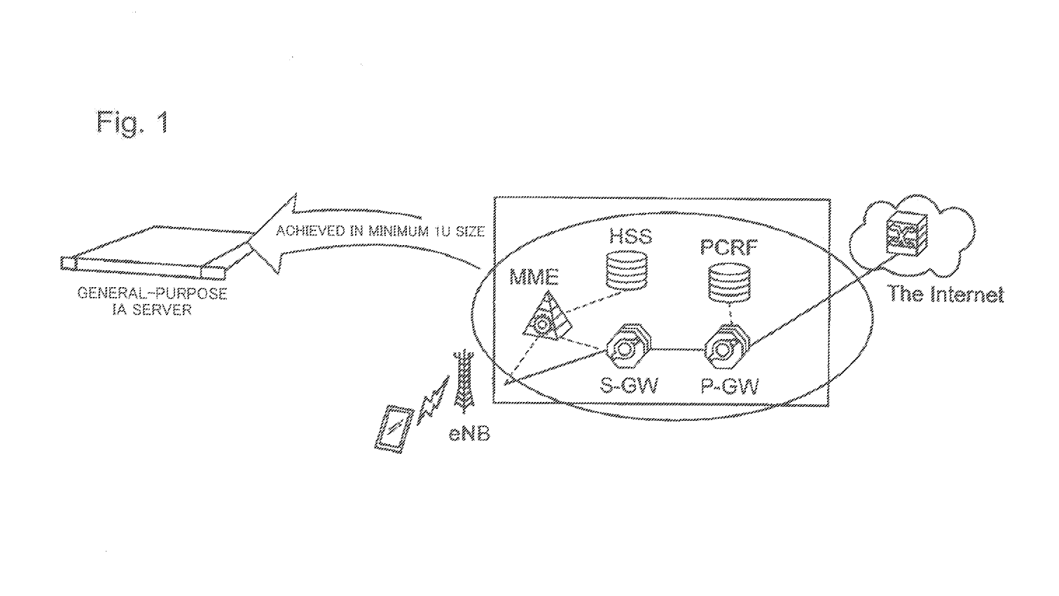

FIG. 2 is a block diagram illustrating a configuration of a packet processing device according to a first example of the present invention;

FIG. 3 is a diagram illustrating an example of a determination table used by the packet processing device illustrated in FIG. 2;

FIG. 4 is a block diagram illustrating a configuration of a queue selector used by the packet processing device illustrated in FIG. 2; and

FIG. 5 is a flowchart for a description of an operation of the queue selector used by the packet processing device illustrated in FIG. 2.

### DESCRIPTION OF EMBODIMENTS

### Related Technologies

To facilitate understanding of the present invention, technologies related to the present invention will be described below.

As described afore, there is a case in which a mobile network, such as an EPC (Evolved Packet Core), which contains an LTE (Long Term Evolution) network and the like, is virtualized by using NFV (Network Functions Virtualization) and the like. In this case, a data plane packet processing device, which processes user data packets from mobile terminals, is achieved on a virtual machine.

NFV is aimed at enabling networks, such as a mobile core, which have been achieved by dedicated hardware, to be achieved by software in a general-purpose server. A data plane packet processing device is achieved as software on a virtual machine that is configured through virtualization on a multi-core CPU mounted on a general-purpose server. The multi-core CPU is provided with a plurality of CPU cores.

To improve the processing performance of the data plane packet processing device on the multi-core CPU, it is required to perform packet processing operations on the plurality of CPU cores and further scale performance in accordance with the number of CPU cores.

To achieve performance scaling in accordance with the number of CPU cores to be used by software processing, the following method is generally employed. First, from an NIC, which is a packet reception unit of a general-purpose server, a reception dedicated core on a virtual machine picks packets. Next, the packets are assigned to the respective CPU cores (packet processing cores). Subsequently, the respective CPU cores (packet processing cores) that have received the packets perform packet processing.

In the method, however, there is a problem in that the CPU resource of the reception dedicated core is consumed more than necessary compared with before the CPU cores are scaled, and, as the number of CPU cores to which packets are distributed increases, the reception dedicated core becomes a bottleneck to prevent the performance scaling from being achieved.

### EXEMPLARY EMBODIMENT

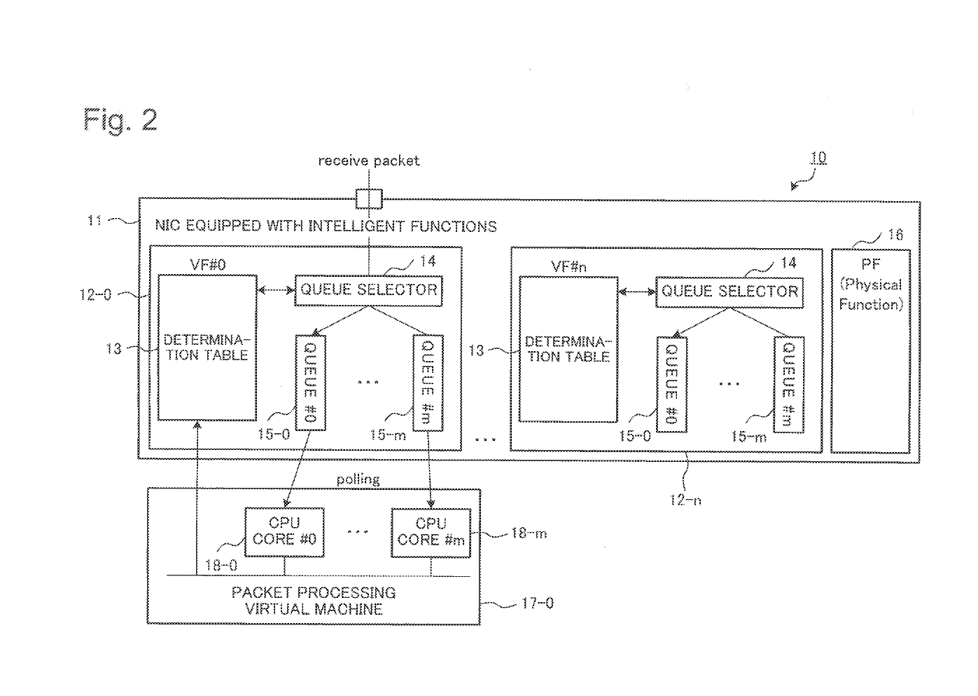

To solve such a problem, an exemplary embodiment of the present invention configures a packet processing device 10 that uses a network interface card (NIC) 11 equipped with intelligent functions as illustrated in FIG. 2.

When the NIC 11, which is equipped with intelligent functions and is inserted into a general-purpose server, receives user data packets, a queue selector 14 performs assignment of the packets and loads the packet data into respective queues 15-0 to 15-m. Here, m is an integer of 2 or greater.

At this time, the queue selector 14 determines assignment destinations based on a determination table 13. Referring to the determination table 13, the queue selector 14 assigns the packet data into proper queues based on CPU utilization rates and the like, which are deployed from 0 to m-th CPU cores 18-0 to 18-m.

In a mobile core network such as an EPC, there are two types of IP addresses, namely a node IP address which is for use in communication between devices in the mobile core network such as an EPC, and a user IP address which is assigned to each of users. User data packets is encapsulated by GTP (General Tunneling Protocol) and provided with a node IP address.

A general-purpose physical NIC may be able to calculate hash values of IP addresses by using an RSS (Receive Side Scaling) function in a VF (Virtual Function) and perform distribution based on the hash values.

However, in an NIC, user data packets in a mobile core network such as an EPC, are generally applied packet assignment based on hash values of node IP addresses. Therefore, in a case of receiving user data packets transmitted from an identical network device or transmitted to an identical network device, the user data packets concentrate on an identical CPU core, which prevents distribution processing of packets from being performed as expected.

Since a user IP address is located in the payload of a packet, packet assignment based on hash values of user IP addresses cannot be performed by the RSS function of a general-purpose NIC.

Therefore, in the exemplary embodiment of the present invention, the determination table 13 creates a hash table which has been determined an assigned queue among the queues 15-0 to 15-m in accordance with a source user IP address or a destination user IP address deployed from the 0 to m-th CPU cores 18-0 to 18-m.

The queue selector 14 extracts a user IP address located in the payload of a received packet, and, after calculating a hash value, selects a queue into which the received packet is stored by referring to the determination table 13. After that, the queue selector 14 refers to CPU utilization rates in the determination table 13. When the CPU utilization rate of the CPU core assigned to the selected queue is higher than or equal to a threshold value, the queue selector 14 determines a queue assigned to a CPU core having the lowest CPU utilization rate among CPU cores having CPU utilization rates lower than or equal to the threshold value.

The queue selector 14 stores the reception packet into the determined queue. When the CPU utilization rates of all the CPU cores are higher than or equal to the threshold value, the queue selector 14 sets a new threshold value between 100% and the last threshold value and performs the same queue selection and determination processing by using the new threshold value. When all the CPU core utilization rates surpass the new threshold value again, the queue selector 14 repeats the same resetting and queue selection and determination processing until the threshold value for the utilization rates reaches 100%.

Each of the 0 to m-th CPU cores 18-0 to 18-m, by polling one of the queues 15-0 to 15-m to which the CPU core is assigned in the NIC 11 equipped with intelligent functions, picks packets as required, and the 0 to m-th CPU cores 18-0 to 18-m perform processing of accepted user data packets.

As described above, in the exemplary embodiment of the present invention, received user data packets are distributed over the respective CPU cores 18-0 to 18-m by the determination table 13 and the queue selector 14 implemented in the NIC 11 equipped with intelligent functions, and the CPU core resources of the respective CPU cores 18-0 to 18-m are smoothed. Therefore, it is possible to use up all the CPU core resources, which enables the processing performance for user data packets to be scaled in accordance with the number of CPU cores.

Hereinafter, with reference to the drawings, an example of the present invention and an operation thereof will be described in detail.

### EXAMPLE 1

FIG. 2 is a block diagram illustrating a configuration of a packet processing device 10 according to a first example of the present invention.

The packet processing device 10 includes an NIC 11 equipped with intelligent functions and a plurality of packet processing virtual machines. In the illustrated example, as the plurality of packet processing virtual machines, a 0-th packet processing virtual machine 17-0 to an n-th packet processing virtual machine (not illustrated), adding up to (n+1) packet processing virtual machines, are included. Here, n is an integer of 1 or greater.

In FIG. 2, the NIC 11 equipped with intelligent functions is furnished with a PF (Physical Function) 16 and a plurality of VFs (Virtual Functions) 12-0 to 12-n. In the PF 16, the plurality of VFs 12-0 to 12-n are virtually configured, and each of the virtual machines 17-0 and so on is able to transmit and receive packets by using one of the VFs 12-0 to 12-n. In this example, as the plurality of VFs, a 0-th VF 12-0 to an n-th VF 12-n, adding up to (n+1) VFs, are included.

The respective ones of the 0-th to n-th VFs 12-0 to 12-n have the same configuration. Therefore, in the following description, the 0-th VF 12-0 will be described as a representative VF, and a description of the other VFs will be omitted.

The 0-th VF 12-0 includes the determination table 13, the queue selector 14, and the plurality of queues 15-0 to 15-m. In the illustrated example, as the plurality of queues, the 0-th queue 15-0 to the m-th queue 15-m, adding up to (m+1) queues, are included.

On the other hand, the 0-th packet processing virtual machine 17-0 includes a plurality of CPU cores 18-0 to 18-m. In the illustrated example, as the plurality of CPU cores, a 0-th CPU core 18-0 to an m-th CPU core 18-m, adding up to (m+1) CPU cores, are included.

As illustrated in FIG. 2, the plurality of queues 15-0 to 15-m individually correspond to the plurality of CPU cores 18-0 to 18-m which are assigned to the 0-th packet processing virtual machine 17-0. To the 0 to m-th queues 15-0 to 15-m, queue numbers of #0 to #m are individually assigned.

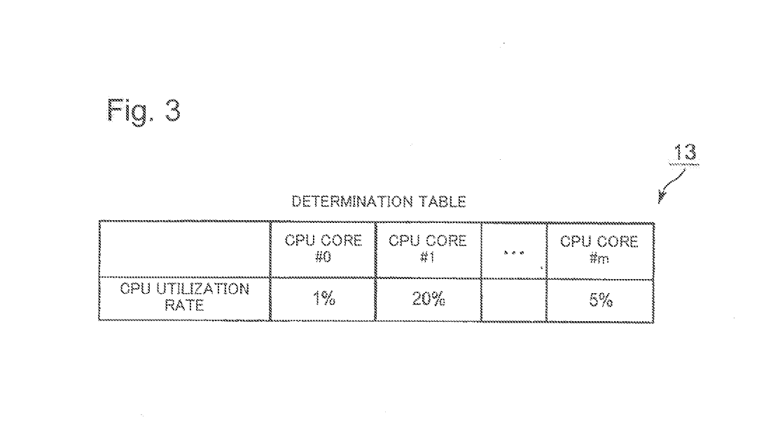

The determination table 13 stores a CPU utilization rate for each of the plurality of CPU cores 18-0 to 18-m, as illustrated in FIG. 3. In the example illustrated in FIG. 3, the CPU utilization rates of the 0-th CPU core 18-0 is 1%, the CPU utilization rates of the 1-st CPU core is 20%, and the CPU utilization rates of the m-th CPU core 18-m is 5%.

In addition to the CPU utilization rates, the determination table 13 stores, as described above, the hash table which has been determined a assigned queue among the queues 15-0 to 15-m in accordance with a source user IP address or a destination user IP address deployed from the plurality of CPU cores 18-0 to 18-m, and call processing information such as a user IP address to be processed.

The packet processing device 10 according to the exemplary embodiment of the present invention, when receiving user data packets by the queue selector 14 in the NIC 11 equipped with intelligent functions, determines whether queue among the 0 to m-th queues 15-0 to 15-m is to be stored the reception packets, as will be described later. That is, the queue selector 14 receives user data packets from mobile terminals as reception packets, and, as will be described later, assigns and stores the reception packet into the plurality of queues 15-0 to 15-m.

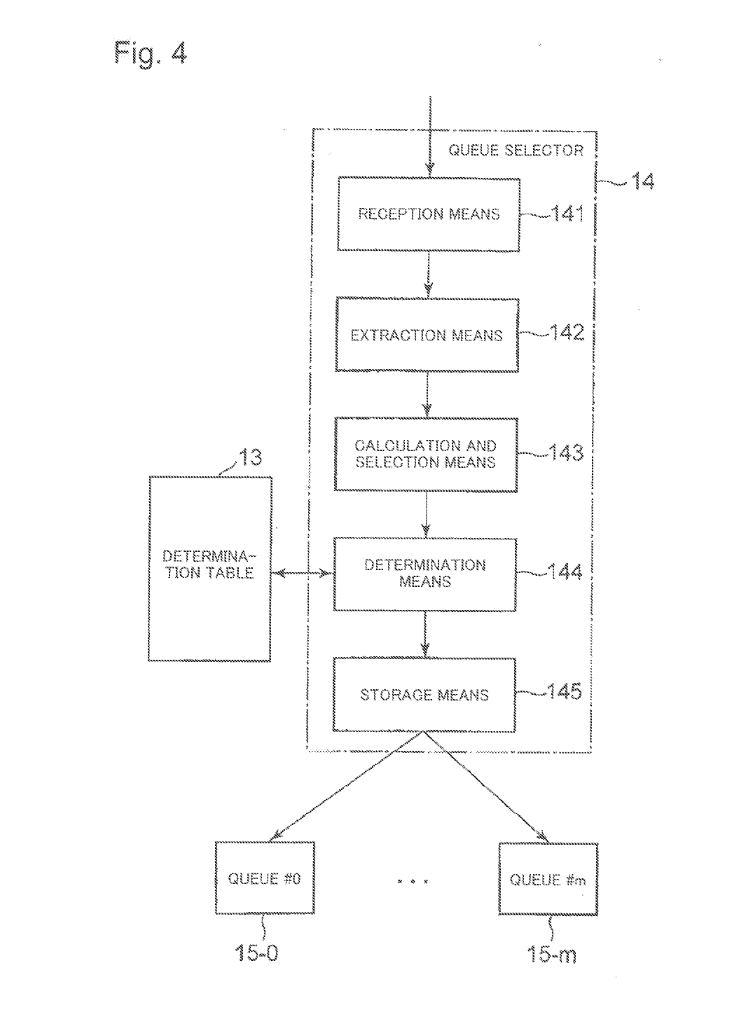

FIG. 4 is a block diagram illustrating a configuration of the queue selector 14. The queue selector 14 includes a reception means 141, an extraction means 142, a calculation and selection means 143, a determination means 144, and a storage means 145.

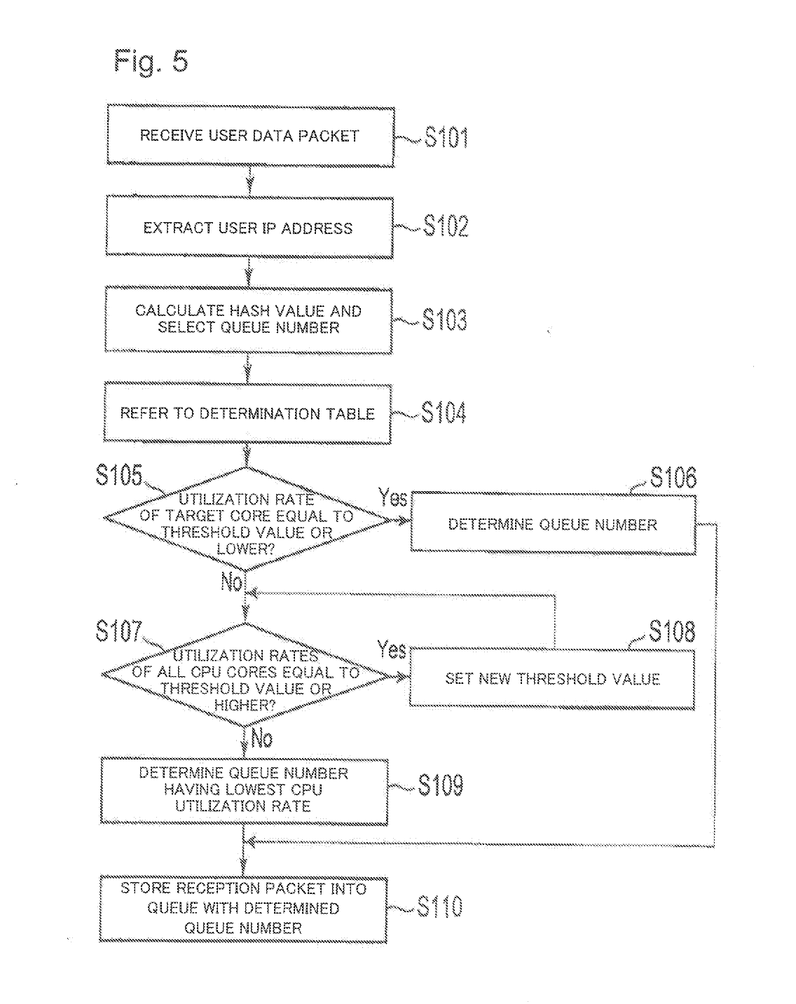

FIG. 5 is a flowchart for a description of an operation of the queue selector 14.

The reception means 141 receives a user data packet as a reception packet (step S101 in FIG. 5). The extraction means 142 extracts a user IP address located in the payload of the reception packet (step S102 in FIG. 5). The calculation and selection means 143 calculates a hash value for the extracted user IP address and, based on the hash value, selects the queue number of a queue into which the reception data is to be stored (step S103 in FIG. 5).

The determination means 144 refers to the determination table 13 (step S104 in FIG. 5), and, based on the CPU utilization rate, determines whether or not the selected queue number is settled as the queue number of a queue into which the reception packet is to be stored, as will be described later (see steps S105 to S109 in FIG. 5).

The storage means 145 stores the reception packet in the queue having the determined queue number (step S110 in FIG. 5).

In the exemplary embodiment, by picking a reception packet out of the queue, enables loads on the CPU cores to be distributed.

Next, with reference to FIG. 5, the operation of the determination means 144 will be described in more detail.

Before determining a queue number based on a hash value, the determination means 144 refers to the determination table 13 (step S104), and, after confirming that the utilization rate of the CPU core assigned to the selected queue number is lower than or equal to a predetermined threshold value (Yes in step S105), determines the queue number (step S106).

Even when reception packets are enabled to be distributed to queues by use of hash values based on user IP addresses, loads on CPU cores are not uniform because of traffic characteristics, such as packet lengths, and the like. Therefore, an imbalance in loads normally occurs with respect to each CPU core.

When the CPU utilization rate of the CPU core is determined to be higher than or equal to the threshold value from the determination table 13 (No in step S105), the determination means 144 determines the queue number of a queue assigned to a CPU core having a utilization rate that is lower than or equal to the threshold value that is lowest (No in step S107, and step S 109). The storage means 145 then stores the reception packet into the queue with the determined queue number (step S110).

When the CPU utilization rates of all the CPU cores are higher than or equal to the threshold value (Yes in step S107), the determination means 144 determines (sets) a new threshold value (step S108) and, based on the new threshold value, determines a queue number in the same logic (steps S107 to S109).

In the determination table 13, information of the CPU utilization rates of the respective CPU cores, which is regularly transmitted from the plurality of CPU cores 18-0 to 18-m allocated to the virtual machine 17-0 in the packet processing device 10, is stored.

In this way, in the example, by smoothing loads on the respective CPU cores 18-0 to 18-m and using all the CPU core resources evenly, it is enable to scale performance in accordance with the number of CPU cores and to use the CPU performance in the hardware maximally.

With reference to FIG. 5, an operation of the queue selector 14 will be described.

The queue selector 14 receives a user data packet as a reception packet (step S101), extracts a user IP address stored in the payload of the reception packet (step S102), and performs calculation of a hash value of the IP address to select the queue number of a queue into which the reception packet is to be stored (step S103).

Before determining the queue number, the queue selector 14 refers to the determination table 13 (step S104), confirms that the CPU utilization rate of the selected CPU core is lower than or equal to a threshold value by referring to information of the CPU utilization rates of the respective CPU cores, which is shown in the determination table 13 (Yes in step S105), and, when the CPU utilization rate is lower than or equal to the threshold value, determines the queue number (step S106).

When the CPU utilization rate is higher than or equal to the threshold value (No in step S105), the queue selector 14 selects and determines the queue number of a queue assigned to a CPU core having a CPU utilization rate that is lower than or equal to the threshold value that is lowest (No in step S107, and step S109). When the utilization rates of all the CPU cores are higher than or equal to the threshold value (Yes in step S107), the queue selector 14 sets a new threshold value again (step S108), and determines a queue number in the same logic (steps S107 to S109).

Each of the CPU cores 18-0 to 18-m picks a packet stored in one of the queues 15-0 to 15-m corresponding to the CPU core, and performs packet processing, such as protocol processing.

As described thus far, the example of the present invention presents advantageous effects as described below.

A first advantageous effect is that it is possible to distribute reception packets without using a CPU core resource, it is possible to distribute reception packets without a reception dedicated core for distributing packets, and it becomes possible to prevent a bottleneck from occurring at a reception dedicated core in scaling the CPU cores, which enables capacity scaling. That is because information of the CPU utilization rates of the respective CPU cores 18-0 to 18-m, which are assigned as the packet processing devices 10, and call processing information, such as a user IP address subjected to processing, are sometimes registered into the determination table 13 in the NIC card, and a queue, to which a CPU core that processes a packet received by the NIC 11 is assigned, is determined in accordance with the determination table 13.

A second advantageous effect is that distributing received packets over the respective CPU cores 18-0 to 18-m with respect to each user of a mobile terminal and smoothing loads on the respective CPU cores enable maximization of packet processing performance as a device to be achieved.

That is because, in functions of the queue selector 14 in the NIC 11, an encapsulated user IP address located in the payload of a reception packet is detected and, by referring to the determination table 13, a queue in the NIC, into which the reception packet is to be stored, is determined in accordance with a hash value of the user IP address and the like.

A third advantageous effect is that eliminating an imbalance in loads on CPU cores caused by variation in the packet lengths and the like of user data packets and smoothing loads on the respective CPU cores enable maximization of packet processing performance as a device to be achieved. That is because CPU cores, the CPU utilization rates of which are lower than or equal to a constant value, are specified in accordance with dynamic CPU utilization rates collected from the respective CPU cores 18-0 to 18-m and put into the determination table 13, and a queue in the NIC 11, into which reception packets are to be stored, is determined.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

### Supplementary Note 1

A reception packet distribution method of receiving a user data packet from a mobile terminal as a reception packet and distributing the reception packet to a plurality of queues, the queues corresponding to a plurality of CPU cores allocated to a virtual machine respectively and assigned queue numbers respectively, the method includes:

receiving the user data packet as the reception packet;

extracting a user IP address located in a payload of the reception packet;

calculating a hash value of the extracted user IP address and selecting a queue number of a queue into which the reception packet is to be stored based on the hash value;

referring to a determination table storing a CPU utilization rate with respect to each of the plurality of CPU cores and determining whether or not the selected queue number is settled as a queue number of a queue into which the reception packet is to be stored based on the CPU utilization rate; and

storing the reception packet into a queue with the determined queue number.

### Supplementary Note 2

The reception packet distribution method according to supplementary note 1, wherein,

when a CPU utilization rate of the CPU core assigned to the selected queue number is lower than or equal to a predetermined threshold value, the determining is to settle the selected queue number as the determined queue number.

### Supplementary Note 3

The reception packet distribution method according to supplementary note 2, wherein,

when a CPU utilization rate of the CPU core assigned to the selected queue number is higher than or equal to the threshold value, the determining is to settle, as the determined queue number, a queue number of a queue assigned to a CPU core with a utilization rate that is lower than or equal to the threshold value and that is lowest.

### Supplementary Note 4

The reception packet distribution method according to supplementary note 3, wherein,

when CPU utilization rates of all CPU cores are higher than or equal to the threshold value, the determining is to determine a new threshold value and determine a queue number of a queue into which the reception packet is to be stored based on the new threshold value.

### Supplementary Note 5

A queue selector that receives a user data packet from a mobile terminal as a reception packet, and allots and stores the reception packet to a plurality of queues, the queues corresponding to a plurality of CPU cores allocated to a virtual machine respectively and assigned queue numbers respectively, the queue selector includes:

reception means for receiving the user data packet as the reception packet;

extraction means for extracting a user IP address located in a payload of the reception packet;

calculation and selection means for calculating a hash value of the extracted user IP address and selecting a queue number of a queue into which the reception packet is to be stored based on the hash value;

determination means for referring to a determination table storing a CPU utilization rate with respect to each of the plurality of CPU cores and determining whether or not the selected queue number is settled as a queue number of a queue into which the reception packet is to be stored based on the CPU utilization rate; and

storage means for storing the reception packet into a queue with the determined queue number.

### Supplementary Note 6

The queue selector according to supplementary note 5, wherein,

when a CPU utilization rate of the CPU core assigned to the selected queue number is lower than or equal to a predetermined threshold value, the determining means determines the selected queue number as the determined queue number.

### Supplementary Note 7

The queue selector according to supplementary note 6, wherein,

when a CPU utilization rate of the CPU core assigned to the selected queue number is higher than or equal to the threshold value, the determining means, as the determined queue number, determines a queue number of a queue assigned to a CPU core with a utilization rate that is lower than or equal to the threshold value and that is lowest.

### Supplementary Note 8

The queue selector according to supplementary note 7, wherein,

when CPU utilization rates of all CPU cores are higher than or equal to the threshold value, the determining means determines a new threshold value and determines a queue number of a queue into which the reception packet is to be stored based on the new threshold value.

### Supplementary Note 9

A packet processing device that receives and processes a user data packet from a mobile terminal as a reception packet, the packet processing device includes:

a plurality of queues that is assigned queue numbers respectively;

a plurality of CPU cores that are allocated to a virtual machine corresponding to the plurality of queues;

a determination table that stores a CPU utilization rate with respect to each of the plurality of CPU cores; and

a queue selector that assigns the reception packet to a proper queue among the plurality of queues by referring to the determination table.

### Supplementary Note 10

The packet processing device according to supplementary note 9, wherein

the queue selector includes:

reception means for receiving the user data packet as the reception packet;

extraction means for extracting a user IP address located in a payload of the reception packet;

calculation and selection means for calculating a hash value of the extracted user IP address and selecting a queue number of a queue into which the reception packet is to be stored based on the hash value;

determination means for referring to a determination table and determining whether or not the selected queue number is settled as a queue number of a queue into which the reception packet is to be stored based on the CPU utilization rate; and

storage means for storing the reception packet into a queue with the determined queue number.

### Supplementary Note 11

The packet processing device according to supplementary note 10, wherein,

when a CPU utilization rate of the CPU core assigned to the selected queue number is lower than or equal to a predetermined threshold value, the determining means determines the selected queue number as the determined queue number.

### Supplementary Note 12

The packet processing device according to supplementary note 11, wherein,

when a CPU utilization rate of the CPU core assigned to the selected queue number is higher than or equal to the threshold value, the determining means, as the determined queue number, determines a queue number of a queue assigned to a CPU core with a utilization rate that is lower than or equal to the threshold value and that is lowest.

### Supplementary Note 13

The packet processing device according to supplementary note 12, wherein,

when CPU utilization rates of all CPU cores are higher than or equal to the threshold value, the determining means determines a new threshold value and determines a queue number of a queue into which the reception packet is to be stored based on the new threshold value.

### Supplementary Note 14

The packet processing device according to any one of supplementary notes 10 to 13, wherein

the plurality of CPU cores periodically transmit and store the respective CPU utilization rates into the determination table.

### Supplementary Note 15

The packet processing device according to any one of supplementary notes 10 to 14, wherein

the plurality of CPU cores pick a reception packet stored in the corresponding queue and perform packet processing respectively.

### Supplementary Note 16

A recording medium that is a computer-readable recording medium storing a program, the program causing a computer to receive a user data packet from a mobile terminal as a reception packet and to distribute the reception packet to a plurality of queues corresponding to a plurality of CPU cores allocated to a virtual machine and assigned queue numbers, the program causing the computer to execute:

a receiving step of receiving the user data packet as the reception packet;

an extraction step of extracting a user IP address located in a payload of the reception packet;

a calculation and selection step of calculating a hash value of the extracted user IP address and selecting a queue number of a queue into which the reception packet is to be stored based on the hash value;

a determination step of referring to a determination table storing a CPU utilization rate with respect to each of the plurality of CPU cores and determining whether or not the selected queue number is settled as a queue number of a queue into which the reception packet is to be stored based on the CPU utilization rate; and

a storage step of storing the reception packet into a queue with the determined queue number.

### Supplementary Note 17

A network interface card (NIC) that receives a user data packet from a mobile terminal as a reception packet and distributes the reception packet to a plurality of CPU cores that are allocated to a plurality of virtual machines respectively, wherein

the network interface card includes: a plurality of VFs (Virtual Functions) and a PF (Physical Function), the plurality of VFs, the plurality of VFs are virtually configured in the PF, each of the virtual machine is capable of transmitting and receiving a packet by using each of VFs, and

each of VFs including:

a plurality of queues that correspond to the plurality of CPU cores and assigned queue numbers respectively;

a determination table that stores a CPU utilization rate of the plurality of CPU cores respectively; and

a queue selector that assigns the reception packet to a proper queue among the plurality of queues by referring to the determination table.

### Supplementary Note 18

The network interface card according to supplementary note 17, wherein

the queue selector includes:

reception means for receiving the user data packet as the reception packet;

extraction means for extracting a user IP address located in a payload of the reception packet;

calculation and selection means for calculating a hash value of the extracted user IP address and selecting a queue number of a queue into which the reception packet is to be stored based on the hash value;

determination means for referring to a determination table and determining whether or not the selected queue number is settled as a queue number of a queue into which the reception packet is to be stored based on the CPU utilization rate; and

storage means for storing the reception packet into a queue with the determined queue number.

### Supplementary Note 19

The network interface card according to supplementary note 18, wherein,

when a CPU utilization rate of the CPU core assigned to the selected queue number is lower than or equal to a predetermined threshold value, the determining means determines the selected queue number as the determined queue number.

### Supplementary Note 20

The network interface card according to supplementary note 19, wherein,

when a CPU utilization rate of the CPU core assigned to the selected queue number is higher than or equal to the threshold value, the determining means, as the determined queue number, determines a queue number of a queue assigned to a CPU core with a utilization rate that is lower than or equal to the threshold value and that is lowest.

### Supplementary Note 21

The network interface card according to supplementary note 20, wherein,

when CPU utilization rates of all CPU cores are higher than or equal to the threshold value, the determining means determines a new threshold value and determines a queue number of a queue into which the reception packet is to be stored based on the new threshold value.

### REFERENCE SINGS LIST

10 Packet processing device
11 Network interface card (NIC) equipped with intelligent function
12-0 to 12-n VF (Virtual Function)
13 Determination table
14 Queue selector
15-0 to 15-m Queue
16 PF (Physical Function)
17-0 Packet processing virtual machine
18-0 to 18-m CPU core

This application is based upon and claims the benefit of priority from Japanese patent application No. 2014-056036, filed on Mar. 19, 2014, the disclosure of which is incorporated herein in its entirety by reference.

1. A reception packet distribution method comprising:
receiving a user data packet from a mobile terminal as a reception packet;
distributing the reception packet to a plurality of queues corresponding to a plurality of CPU cores allocated to a virtual machine respectively and assigned queue numbers respectively;
receiving the user data packet as the reception packet;
extracting a user IP address located in a payload of the reception packet;
calculating a hash value of the extracted user IP address and selecting a queue number of a queue into which the reception packet is to be stored based on the hash value;
referring to a determination table storing a CPU utilization rate with respect to each of the plurality of CPU cores and determining whether or not the selected queue number is settled as a queue number of a queue into which the reception packet is to be stored based on the CPU utilization rate; and
storing the reception packet into a queue with the determined queue number.

2. The reception packet distribution method according to claim 1, wherein,
when a CPU utilization rate of the CPU core assigned to the selected queue number is lower than or equal to a predetermined threshold value, determining the selected queue number as the determined queue number.

3. The reception packet distribution method according to claim 2, wherein,
when a CPU utilization rate of the CPU core assigned to the selected queue number is higher than or equal to the threshold value, determining, as the determined queue number, a queue number of a queue assigned to a CPU core with a utilization rate that is lower than or equal to the threshold value and that is lowest.

4. The reception packet distribution method according to claim 3, wherein,
when CPU utilization rates of all CPU cores are higher than or equal to the threshold value, determining a new threshold value and determining a queue number of a queue into which the reception packet is to be stored based on the new threshold value.

5. (canceled)

6. A packet processing device that receives and processes a user data packet from a mobile terminal as a reception packet, the packet processing device comprising:
a plurality of queues that is assigned queue numbers respectively;
a plurality of CPU cores that are allocated to a virtual machine corresponding to the plurality of queues;
a determination table that stores a CPU utilization rate with respect to each of the plurality of CPU cores; and
a queue selector that assigns the reception packet to a proper queue among the plurality of queues by referring to the determination table.

7. The packet processing device according to claim 6, wherein
the plurality of CPU cores periodically transmit and store the respective CPU utilization rates into the determination table.

8. The packet processing device according to claim 6, wherein
the plurality of CPU cores pick a reception packet stored in the corresponding queue and perform packet processing respectively.

9. A computer readable non-transitory recording medium embodying a program, the program causing a computer to perform a method, the method comprising:
receiving a user data packet from a mobile terminal as a reception packet;
distributing the reception packet to a plurality of queues corresponding to a plurality of CPU cores allocated to a virtual machine respectively and assigned queue numbers respectively;
receiving the user data packet as the reception packet;
extracting a user IP address located in a payload of the reception packet;
calculating a hash value of the extracted user IP address and selecting a queue number of a queue into which the reception packet is to be stored based on the hash value;
referring to a determination table storing a CPU utilization rate with respect to each of the plurality of CPU cores and determining whether or not the selected queue number is settled as a queue number of a queue into which the reception packet is to be stored based on the CPU utilization rate; and
storing the reception packet into a queue with the determined queue number.

10. (canceled)

11. The packet processing device according to claim 7, wherein
the plurality of CPU cores pick a reception packet stored in the corresponding queue and perform packet processing respectively.
